(19) United States
(12) Patent Application Publication
(10) Pub. No.: US 2010/0322597 A1
(43) Pub. Date: Dec. 23, 2010

(54) METHOD OF COMPRESSION OF GRAPHICS IMAGES AND VIDEOS

(75) Inventors: Mohammad Gharavi-Alkhansari, Santa Clara, CA (US); Wei Liu, San Jose, CA (US); Ali Tabatabai, Cupertino, CA (US)

Correspondence Address: HAVERSTOCK & OWENS LLP, 162 N WOLFE ROAD, SUNNYVALE, CA, 94086, US

(73) Assignee: SONY CORPORATION, Tokyo (JP)

(21) Appl. No.: 12/820,659

(22) Filed: Jun. 22, 2010

Related U.S. Application Data
(60) Provisional application No. 61/269,267, filed on Jun. 22, 2009.

(51) Int. Cl. H04N 7/12; H04N 7/26

(52) U.S. Cl. 386/328; 375/240.24; 375/E07.076; 386/E05.003

(57) ABSTRACT

Compression of graphics images and videos includes partitioning an image into blocks, determining the number of bitplanes for encoding each block, encoding the block by grouping pixel values so that within each group, the pixel values are the same or similar, sending the number of bitplanes, sending the number of groups and the pixel value of each group and sending a signal for each pixel to indicate the group for that pixel, as well as using leftover bits from a bit budget for sending refinement bits for pixels.

### RELATED APPLICATION(S)

This application claims the priority under 35 U.S.C. §119(e) of U.S. Provisional Patent Application Ser. No. 61/269,267, filed Jun. 22, 2009, and entitled “A METHOD OF COMPRESSION OF GRAPHICS IMAGES AND VIDEOS,” which is hereby incorporated by reference in its entirety for all purposes.

### FIELD OF THE INVENTION

The present invention relates to the field of image processing. More specifically, the present invention relates to compression of graphics in images and videos.

### BACKGROUND OF THE INVENTION

There are numerous methods proposed for compression of digital images and videos. There are also several standards developed for image and video compression, including JPEG for image compression, and MPEG1, MPEG2, MPEG4, H.261, H.263 and H.264 for video compression. Image and video compression algorithms typically work based on an assumption about the nature of the images to be compressed. For natural images and videos, a common assumption is the presence of strong correlation between the values of neighboring pixels. That is, the assumption that the values of neighboring pixels are typically close to each other. However, for a variety of synthetic images generated by computers, the assumption does not hold.

### SUMMARY OF THE INVENTION

Compression of graphics images and videos includes partitioning an image into blocks, determining the number of bitplanes for encoding each block, encoding the block by grouping pixel values so that within each group, the pixel values are the same or similar, sending the number of groups and the pixel value of each group and sending a signal for each pixel to indicate the group for that pixel, as well as using leftover bits from a bit budget for sending refinement bits for each pixel.

In one aspect, a method of compression programmed in a controller in a device comprises partitioning an image into blocks, determining a bit plane quantity for encoding each of the blocks and encoding each of the blocks by grouping at least similar pixel values into groups. The method further comprises using remaining bits from a bit budget to send refinement bits for pixels. Encoding each of the blocks includes sending a bit depth of groups, the number of groups, a pixel value of each of the groups and a signal for each pixel to indicate a group of the groups for each pixel. The bit depth of groups comprises the number of bitplanes used for grouping (qDepthBest), a group quantity. Same pixel values are grouped into the groups. The controller is selected from the group consisting of a programmed computer readable medium and an application-specific circuit. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

In another aspect, a method of compression programmed in a controller in a device comprises partitioning an image into blocks, determining an average of pixel values of each block of the blocks, locating the pixel values greater than or equal to the average, tagging the pixel values greater than or equal to the average as a first group and tagging remaining pixel values as a second group. The above steps are repeated n times to generate 2ⁿ groups, where n can be 1, 2, 3, . . . a maximum.

In another aspect, a system for compression programmed in a controller in a device comprises a partitioning module for partitioning an image into blocks, a determining module for determining a bit plane quantity for encoding each of the blocks and an encoding module for encoding each of the blocks by grouping at least similar pixel values into groups. The system further comprises a refinement module for using remaining bits from a bit budget to send refinement bits for pixels. Encoding each of the blocks includes sending a bit depth of groups, the number of groups, a pixel value of each of the groups and a signal for each pixel to indicate a group of the groups for each pixel. Same pixel or similar values are grouped into the groups. The controller is selected from the group consisting of a programmed computer readable medium and an application-specific circuit. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

In another aspect, a system for compression programmed in a controller in a device comprises a natural image sub-codec for encoding natural images and a graphics image sub-codec for encoding graphics images. The graphics image sub-codec is implemented by partitioning an image into blocks, determining a bit plane quantity for encoding each of the blocks and encoding each of the blocks by grouping at least similar pixel values into groups. The controller is selected from the group consisting of a programmed computer readable medium and an application-specific circuit. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

In yet another aspect, a camcorder device comprises a video acquisition component for acquiring a video, a memory for storing an application, the application for partitioning an image of the video into blocks, determining a bit plane quantity for encoding each of the blocks and encoding each of the blocks by grouping at least similar pixel values into groups and a processing component coupled to the memory, the processing component configured for processing the application. The application is further for using remaining bits from a bit budget to send refinement bits for pixels. Encoding each of the blocks includes sending a bit depth of groups, the number of groups, a pixel value of each of the groups and a signal for each pixel to indicate a group of the groups for each pixel. Same pixel values are grouped into the groups.

### BRIEF DESCRIPTION OF THE DRAWINGS

FIG. 1 illustrates two examples of blocks containing groups of the same values.

FIG. 2 illustrates two examples of blocks containing groups of similar values.

FIGS. 3A-R illustrate graphs of an example of grouping according to some embodiments.

FIG. 4 illustrates a block diagram of an exemplary computing device configured to implement the compression method according to some embodiments.

FIG. 5 illustrates a flowchart of a method of encoding a video according to some embodiments.

### DETAILED DESCRIPTION OF THE PREFERRED EMBODIMENT

A method of compression of synthetic (graphic) images is described herein. An image is partitioned into blocks. Each image block is encoded to generate a fixed and preset number of bits. Each block is encoded independently from other blocks in the image. In some embodiments, each color component of each block is coded independently from other color components. In some embodiments, the different color components of a block are coded jointly so that the different color components share their bit budget and the block header bits. A block size of 8×2 is used as an example herein, although the block size is able to be any size including the entire image.

A bit depth, to which we also refer as depth, is the number of bits needed to represent the largest possible pixel value. For example, if the pixel values are in the range 0 to 1023, the bit depth is 10. In general, the pixel values are considered to be in the range 0 to (2^{depth}-1). A bit depth of 10 is utilized herein, although any bit depth is able to be used.

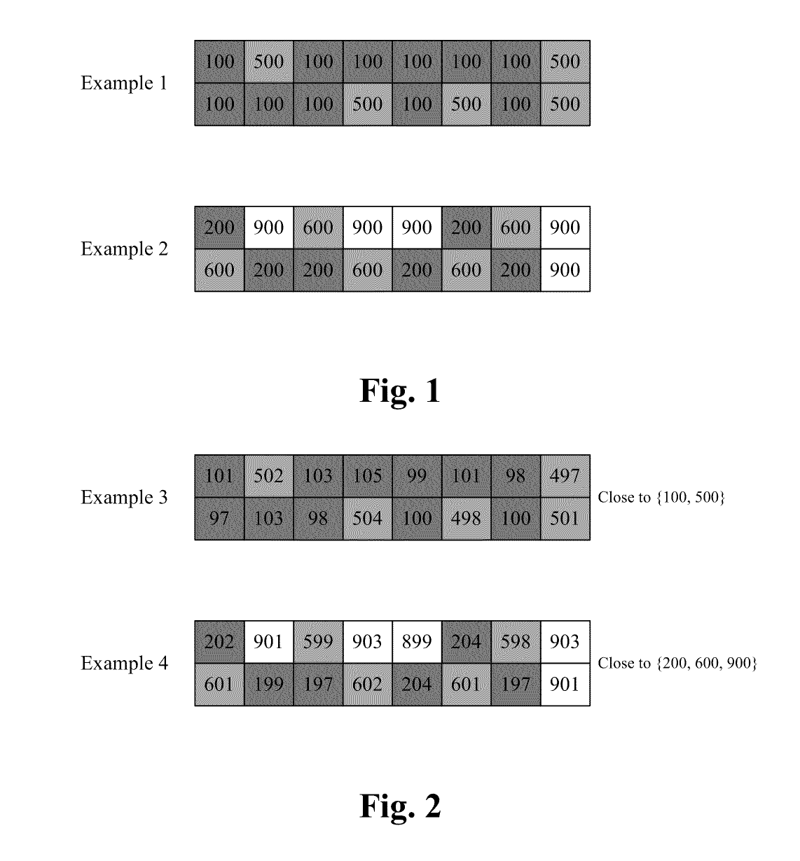

When image blocks have the same or similar bit values within, the bit values are able to be grouped. FIG. 1 illustrates two examples of blocks containing groups of the same values. In Example 1, there are pixel values of 100 and 500. In Example 2, there are pixel values of 200, 600 and 900. The pixel values in the Example 1 are able to be grouped into two groups, a first group with pixel values of 100 and a second group with pixel values of 500. The pixel values in the Example 2 are able to be grouped into three groups, a first group with pixel values of 200, a second group with pixel values of 600 and a third group of pixel values of 900.

For natural images, blocks that are able to be grouped this way are not very common. However, for computer generated images, these types of blocks are common. In a simplified version of a method of compression of images where pixels are able to be grouped, it is assumed that pixel values are exact matches, such as those shown in FIG. 1. Then, the encoding process groups the pixel values in the block, so that within each group, the pixel values are the same. The number of groups are sent. The value of each group is then sent. For each pixel, a signal is sent indicating to which group the pixel belongs. For example, using Example 1 above, a “2” is first sent, indicating two groups of values in the block, then a “100” is sent, indicating the pixels in group one have a value “100” and then a “500” is sent, indicating the pixels in group two have a value “500.” For each pixel, the group number is sent, such as a “1,” indicating group one and a “2,” indicating group two.

In some cases, the pixel values in an image block are not necessarily members of a small set, but are “close” to members of a small set. FIG. 2 illustrates two examples of blocks containing groups of similar values. In the Example 3, there are pixel values near 100 and near 500. In the Example 4, there are pixel values near 200, near 600 and near 900.

As described above, a simplified compression process is possible if many pixel values are the same. However, additional steps are utilized if pixel values are similar but not the same. Since not all of the bits of the bitbudget are utilized for coding, the unused bits are able to be used to introduce refinement at the codec. The refinement is able to be similar to that described in U.S. patent application Ser. No. 12/789,010, filed May 27, 2010, and entitled, “AN IMAGE COMPRESSION METHOD WITH RANDOM ACCESS CAPABILITY, which is incorporated by reference herein.

The encoder encodes the most significant bitplanes of the pixels by using groups. If any bits from the bit budget are left unused, they are used for refinement of the pixel values. Any bitplanes of the original pixels that are not coded by the encoder are estimated by the decoder.

Encoder

For each of all possible number of bitplanes (qDepth=1 to 10), starting from the most significant bitplane (MSB) and going to the least significant bitplane (LSB), the encoder determines many items. If the encoding process stops at the end of the current bitplane, the number of groups with exact matches found are determined by taking into account only bitplanes 1 to qDepth. The number of bits needed to transmit the groups using the concept of exact matches is determined. The number of bits (if any) remaining to be used for refinement are then determined. Using the combination of both the group coding and refinement, the number of bits coded losslessly is determined.

At the encoder, when all of the above values are computed for all qDepth values, the encoder compares the losslessly coded bits obtained for each of the qDepth values, and the qDepth with the largest amount of losslessly coded bits wins and that qDepth is selected. For the selected qDepth, the following values are coded into the bitstream using fixed length codes: the selected qDepth, the number of groups (at the end of the bitplane number qDepth), the values of the groups (only the most significant qDepth bits for each group), the group number of each pixel (considering only bit planes 1 to qDepth). If there are any remaining bits in the bit budget, refinement bits are sent for the pixels in the block. For a given color component, the same number of refinement bits is sent for the pixels in the block until the bit budget is reached (e.g. refinement bit budget is exhausted) or until the block is coded losslessly, which ever happens first. For example, a refinement bit is sent for all of the pixels or two refinement bits are sent for all of the pixels. In some embodiments, refinement allows different refinement bits to be sent for pixels in a block as long as for each group either all of the pixels in the group get the refinement bits for one bitplane or none of them.

There are several ways for determining the number of groups for each qDepth. In an embodiment, pixel values of the block are first ordered in one row, according to raster scan order. Then, the result is converted into bitplanes. For each pixel, the group number is computed and stored in an element of an array. The encoder scans the bitplanes in a raster scan order. In some embodiments, the bitplanes are configured in a 2D array. The first index of the 2D array is denoted by qDepth and the second index is denoted by “ii.” Hence, a general element of the 2D array is able to be specified as array(qDepth, ii). Before starting a scan, the pixels are tagged as members of group 1. When the first bit of the first pixel is scanned (e.g. array(1, 1)), the bit value becomes the value of the group 1 at qDepth=1. For the remaining elements of the array in the first row, that is, for array(1, ii) with “ii” changing from 1 to 16, if array(1, ii) is equal to array(1,1), then the group number of the pixel “ii” remains 1 as before (no change). However, if array(1, ii) is not equal to array(1,1) which is referred to as a bit mismatch, then the first time this happens, a new group is generated (e.g. group 2) and the group number of pixel “ii” is changed from group 1 to group 2. However, the next time(s) in the first row that a bit mismatch happens, even though the group number for pixel “ii” from group number 1 to group number 2 is changed, group 2 is not generated again. Hence, for group 1, a 1-bit flag is used for indicating whether for previous members of the group with mismatch, a new group has already been generated. In the first row, it is obvious that when a bit match occurs and the flag is set, then the number of the new group is 2. However, in the following bitplanes, the number of the new group is not obvious, and therefore when the new group is generated, the number of the new group is stored. For example, a flag, .hasNext, indicates if a new group has been generated and .next indicates the group number of the newly generated group. For example, in the first row of the array, for group 1, at the first bit mismatch, .hasNext of group 1 is set to 1 and .next of group 1 is set to 2, meaning that from this point on in the current plane, any member of group 1 which will have a mismatch with group 1 in the current bitplane will be tagged as group 2 without the need to generate a new group.

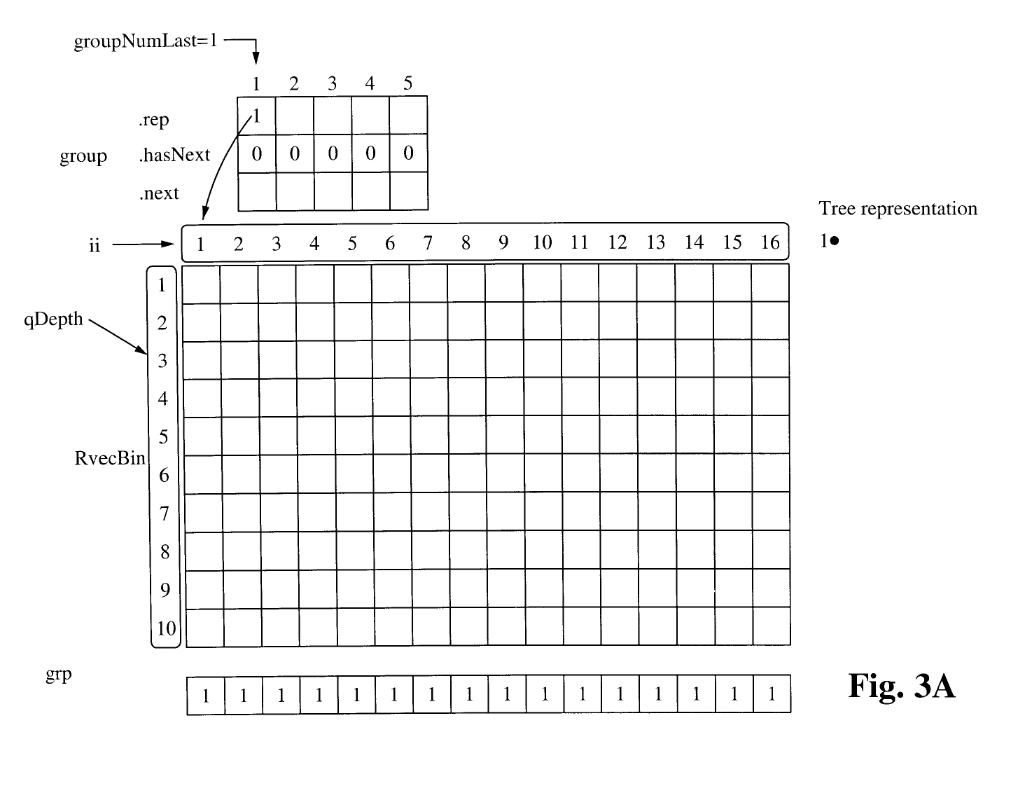

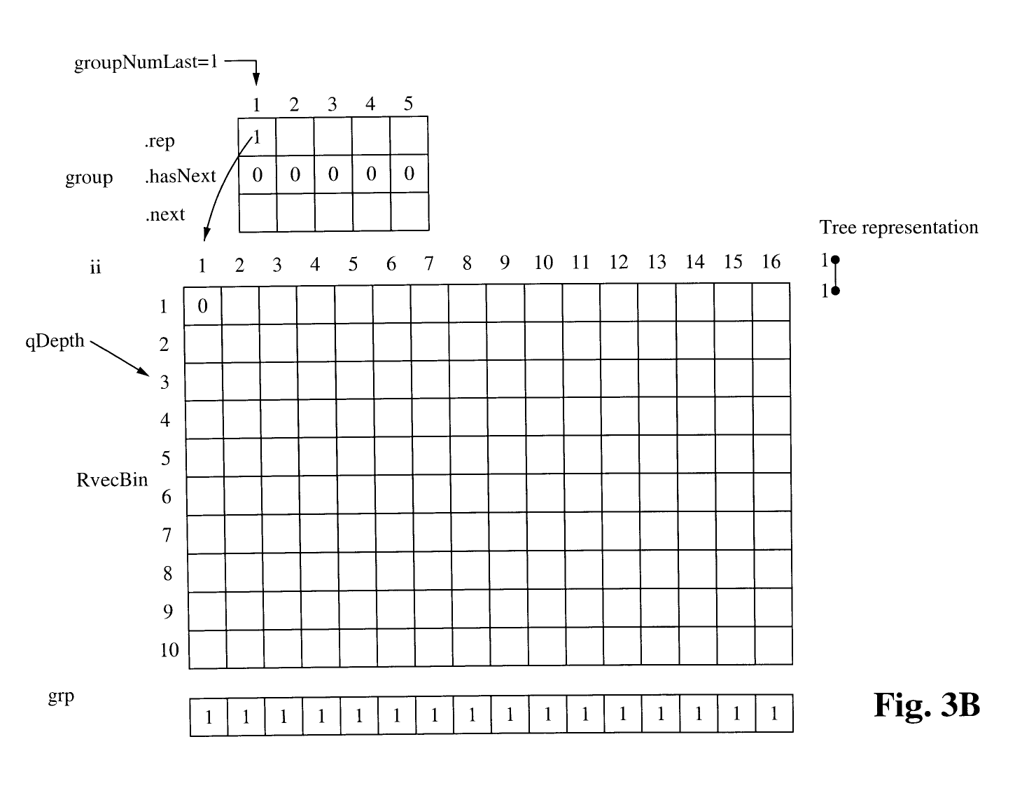

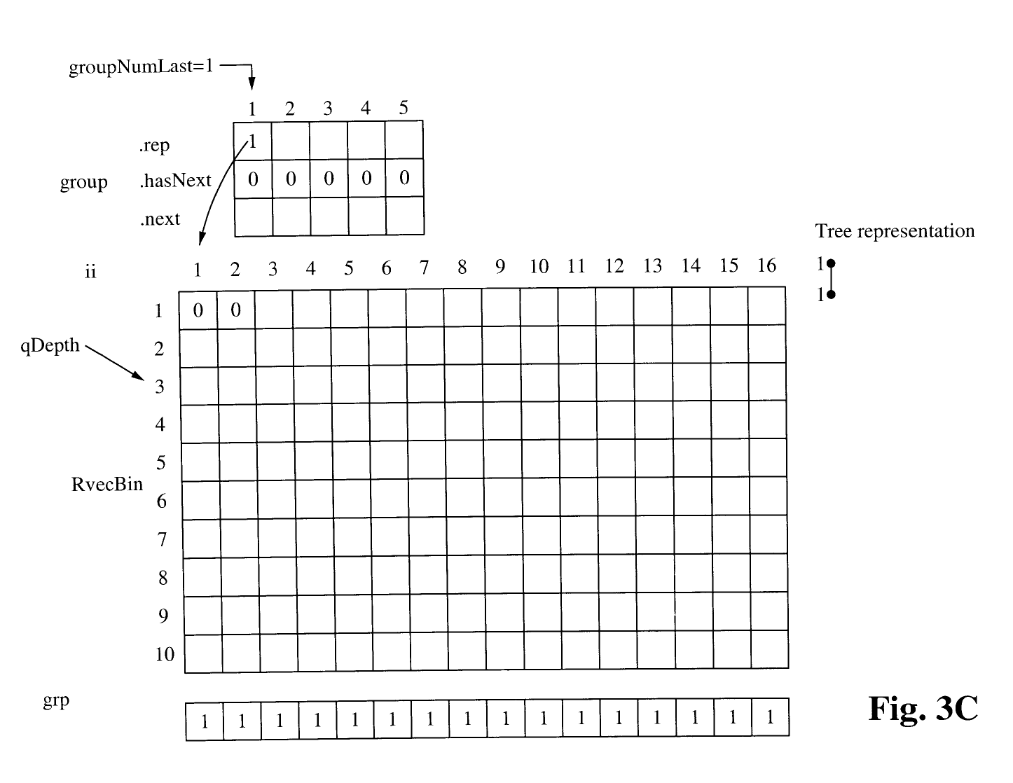

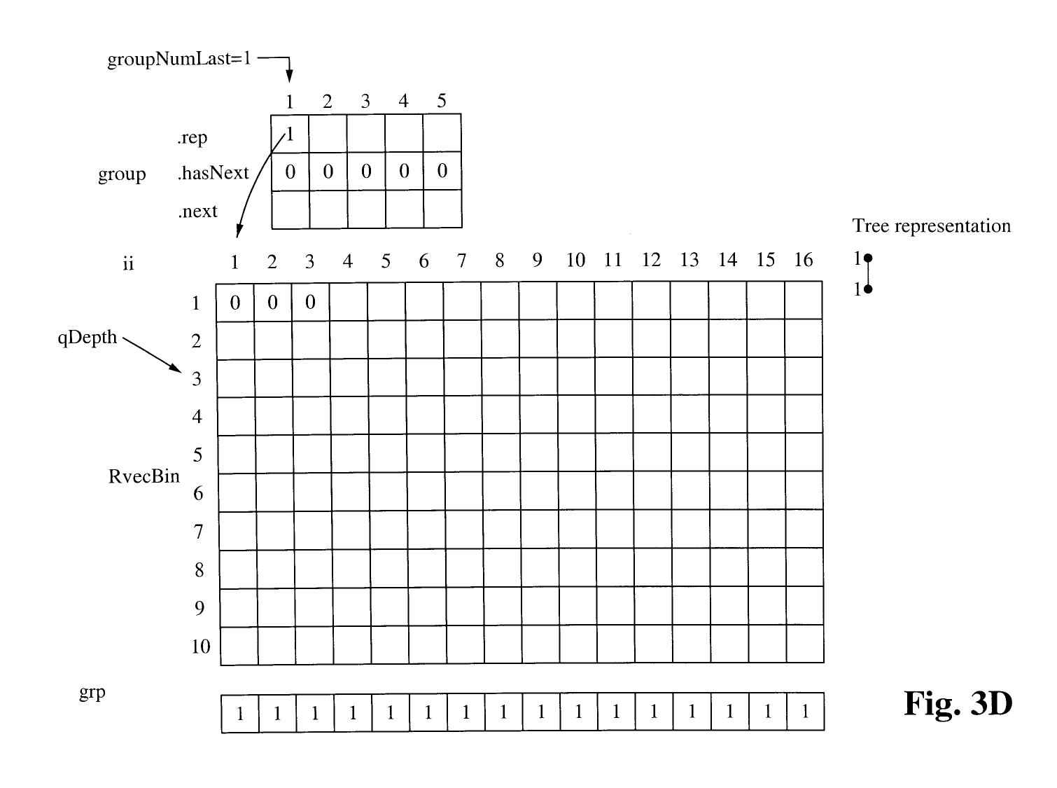

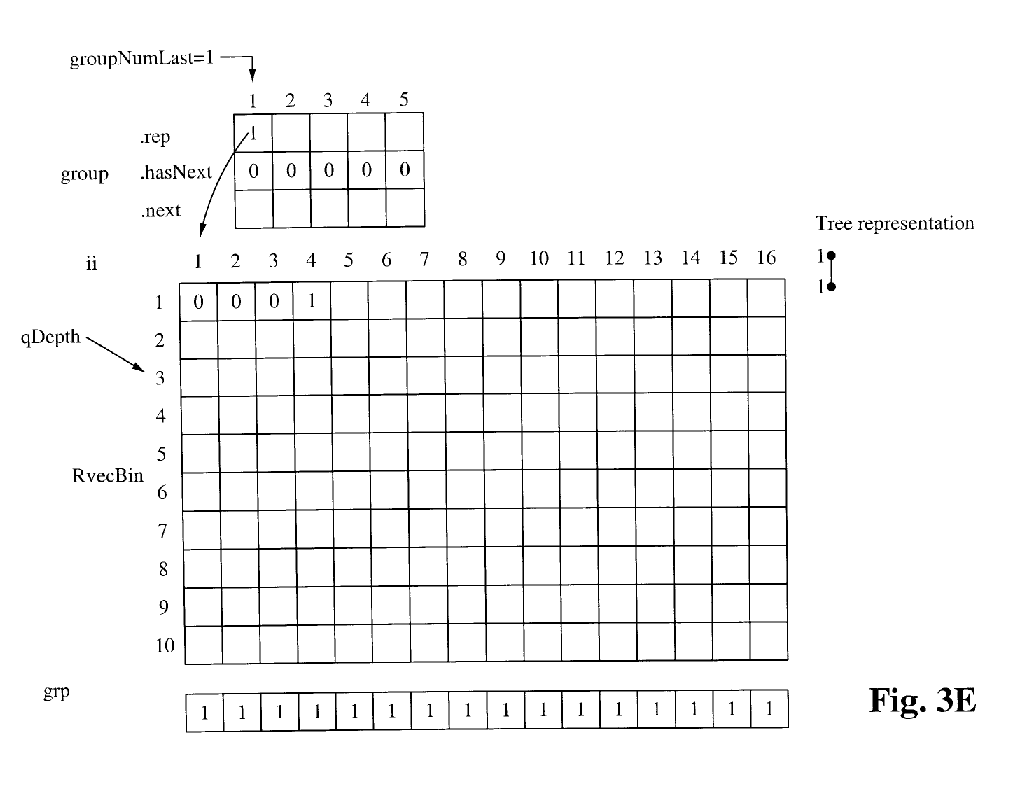

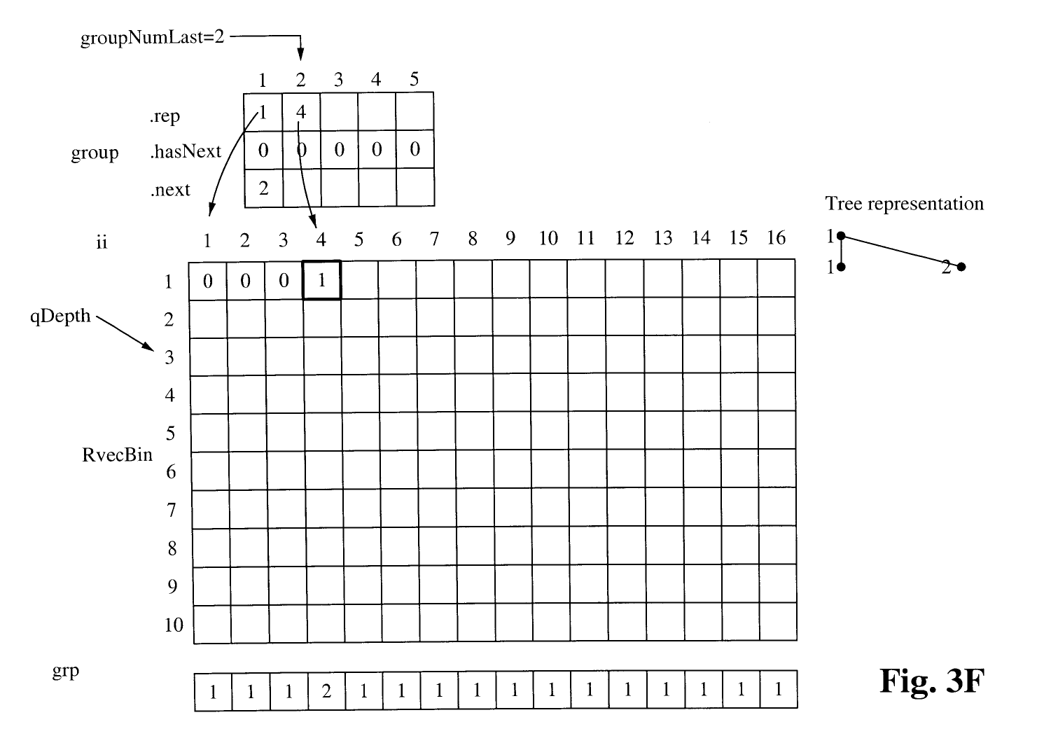

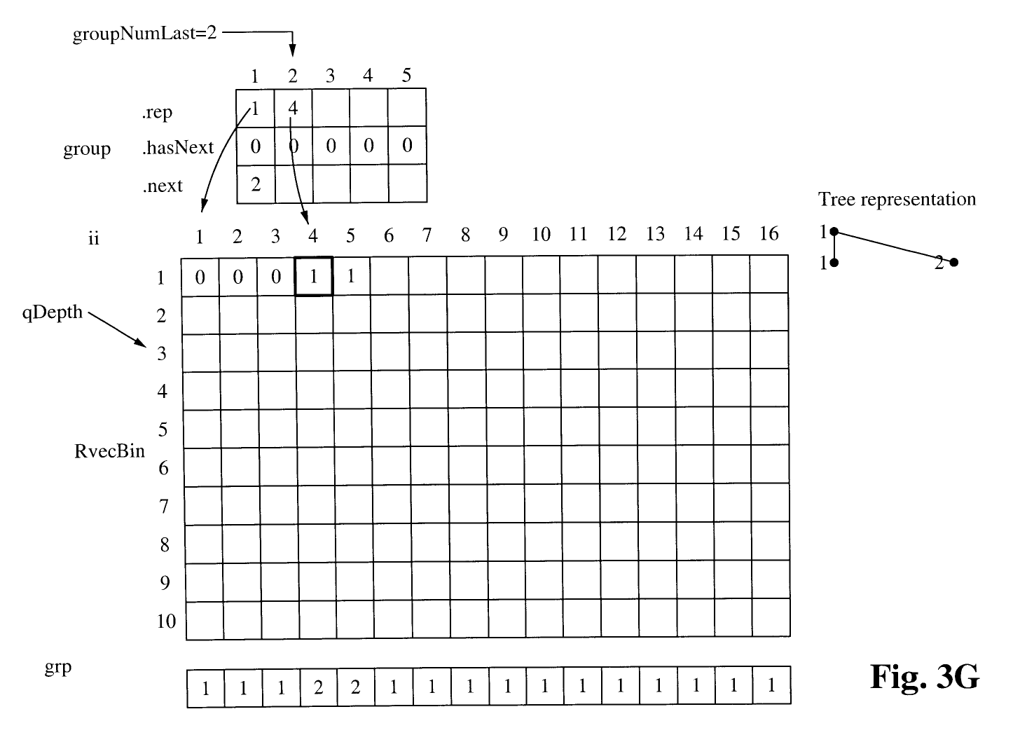

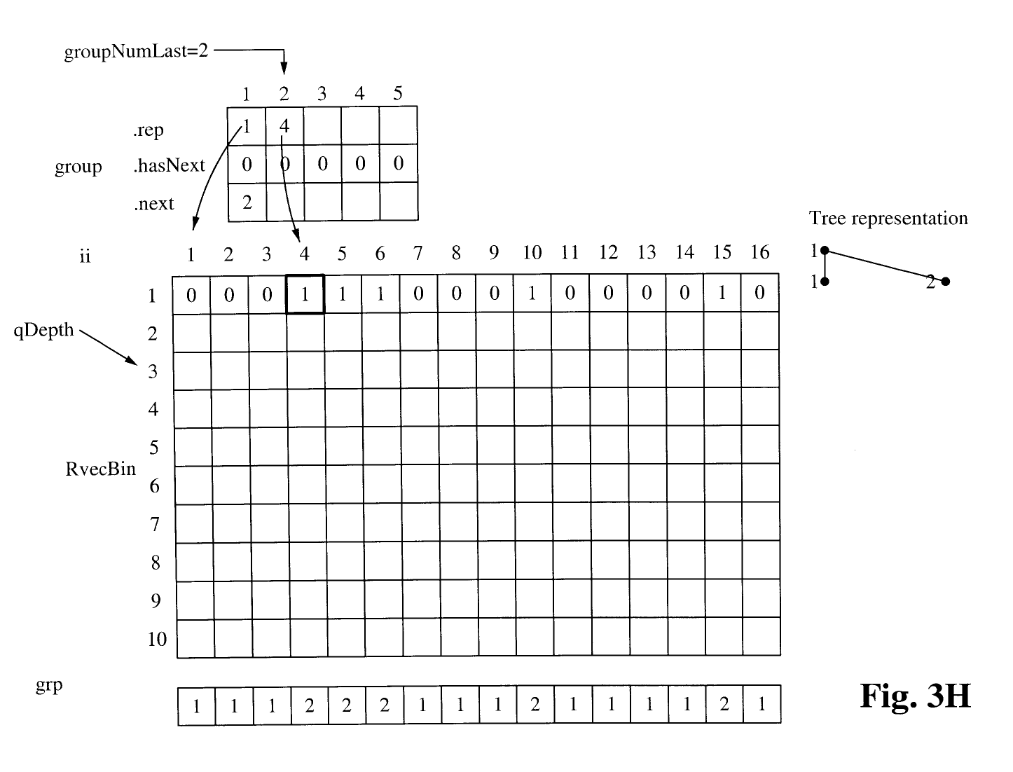

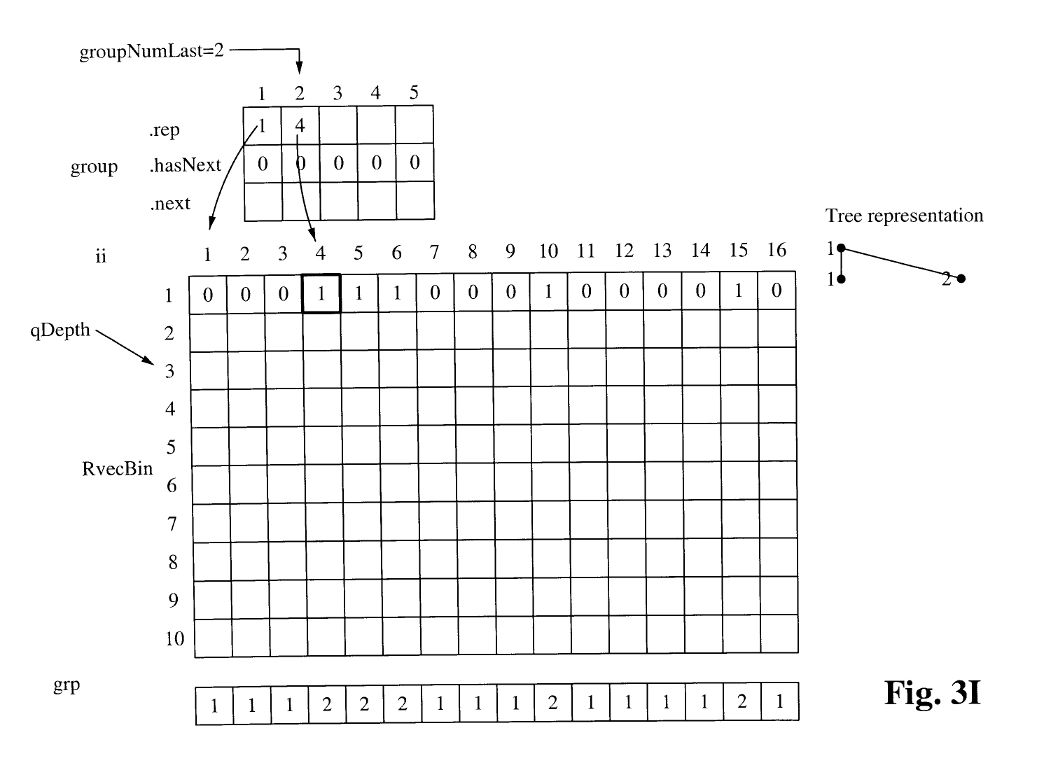

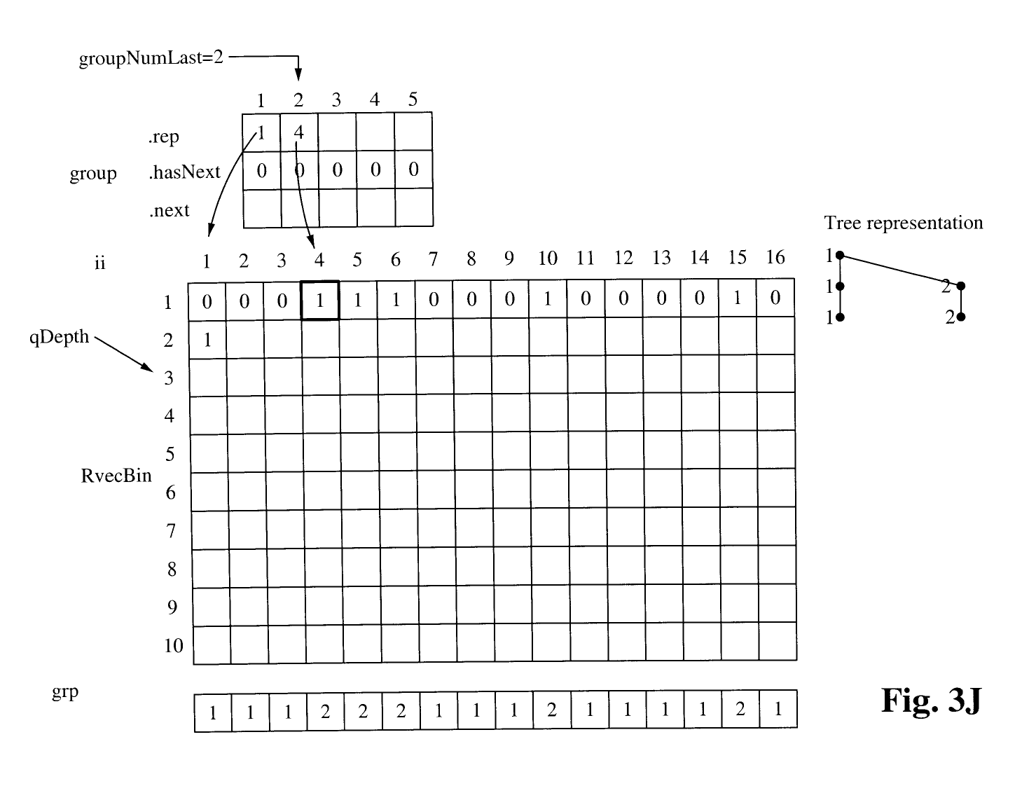

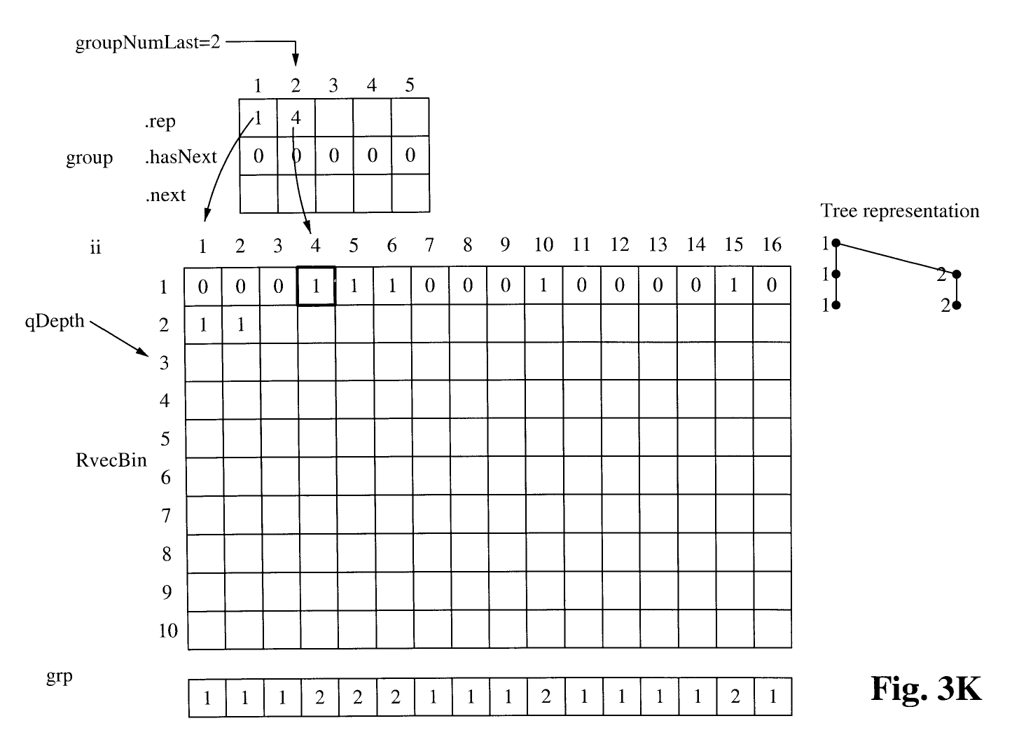

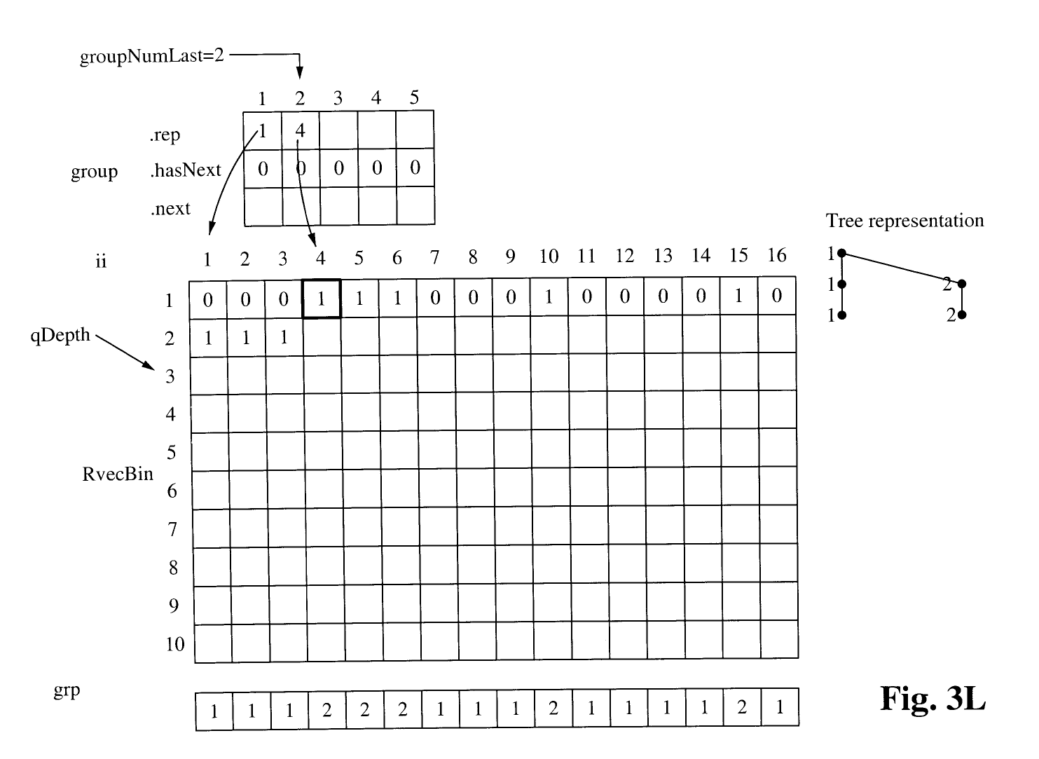

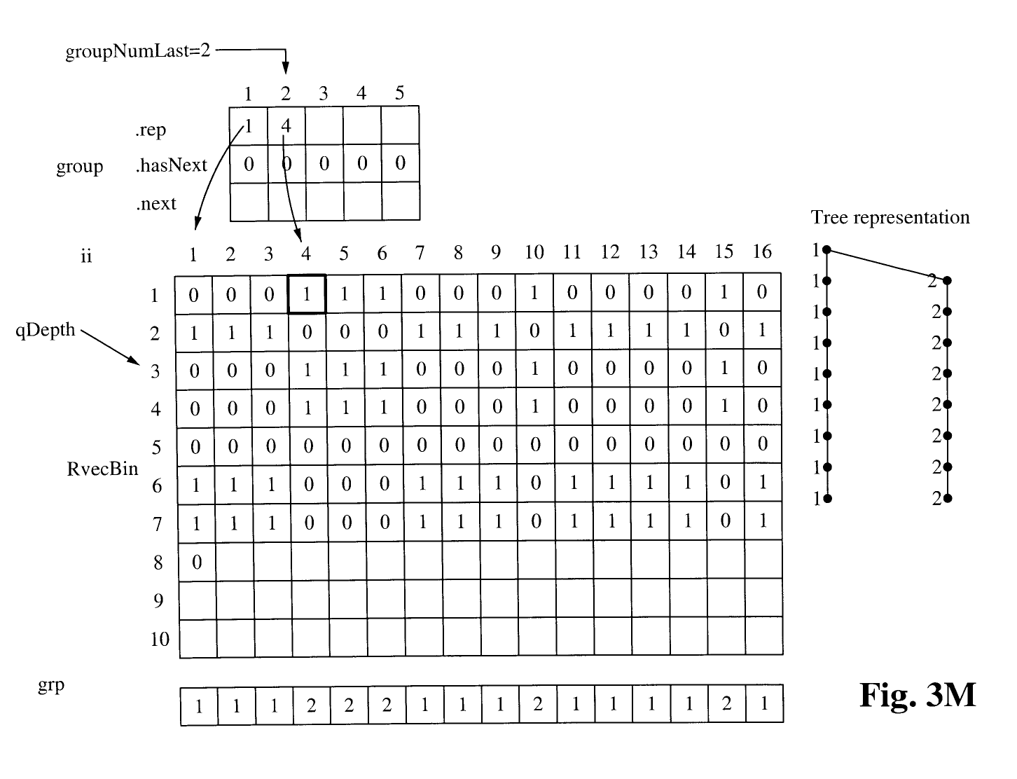

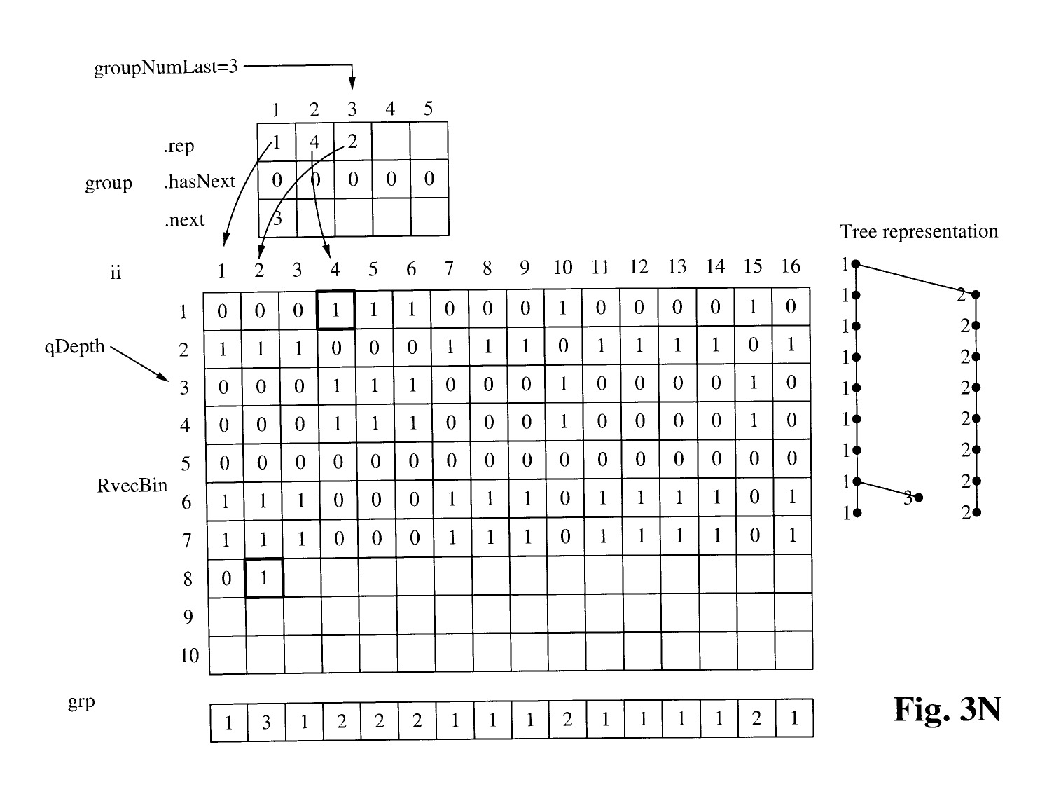

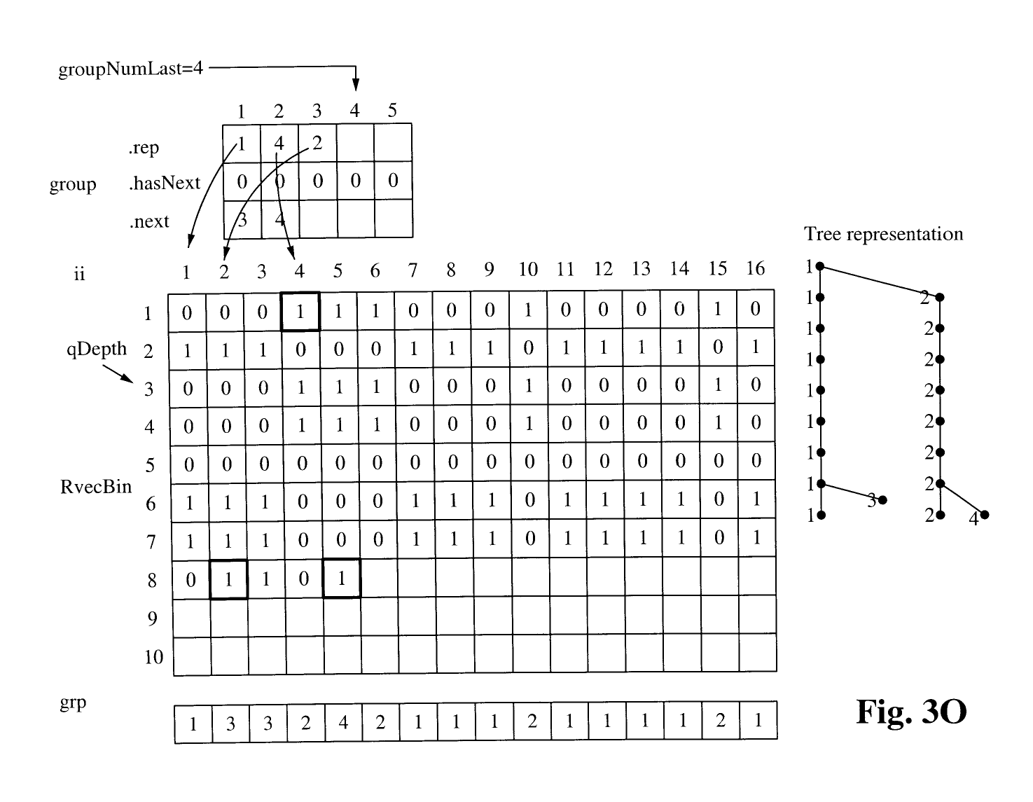

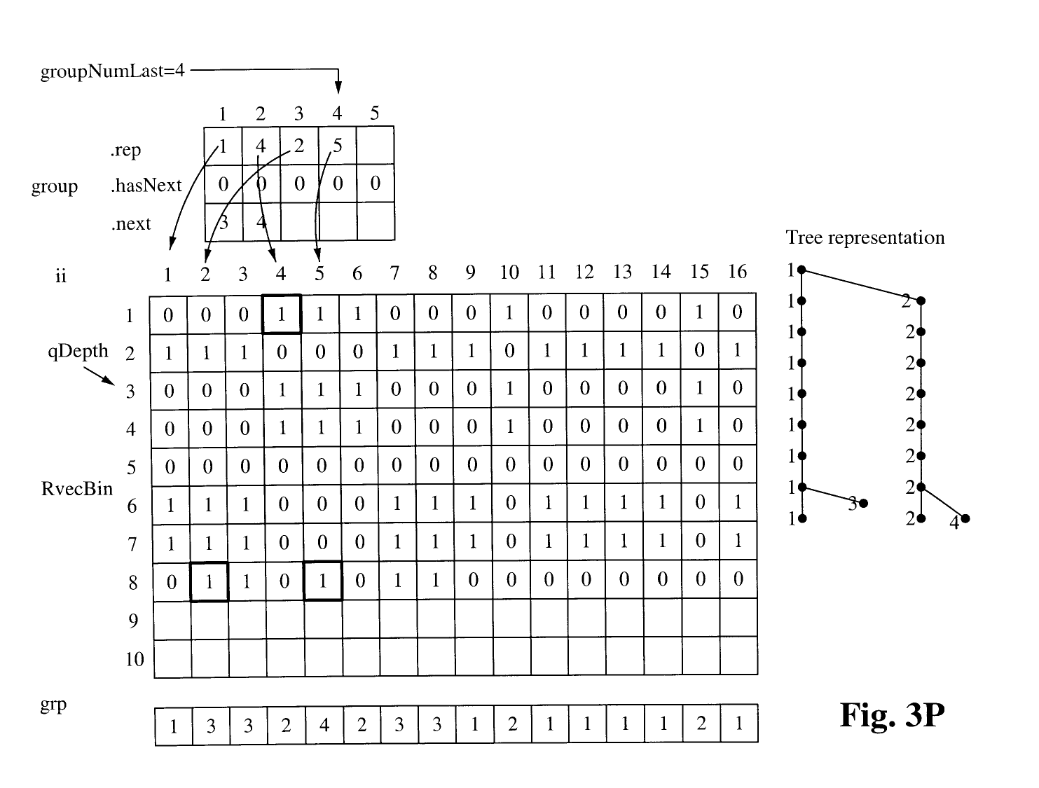

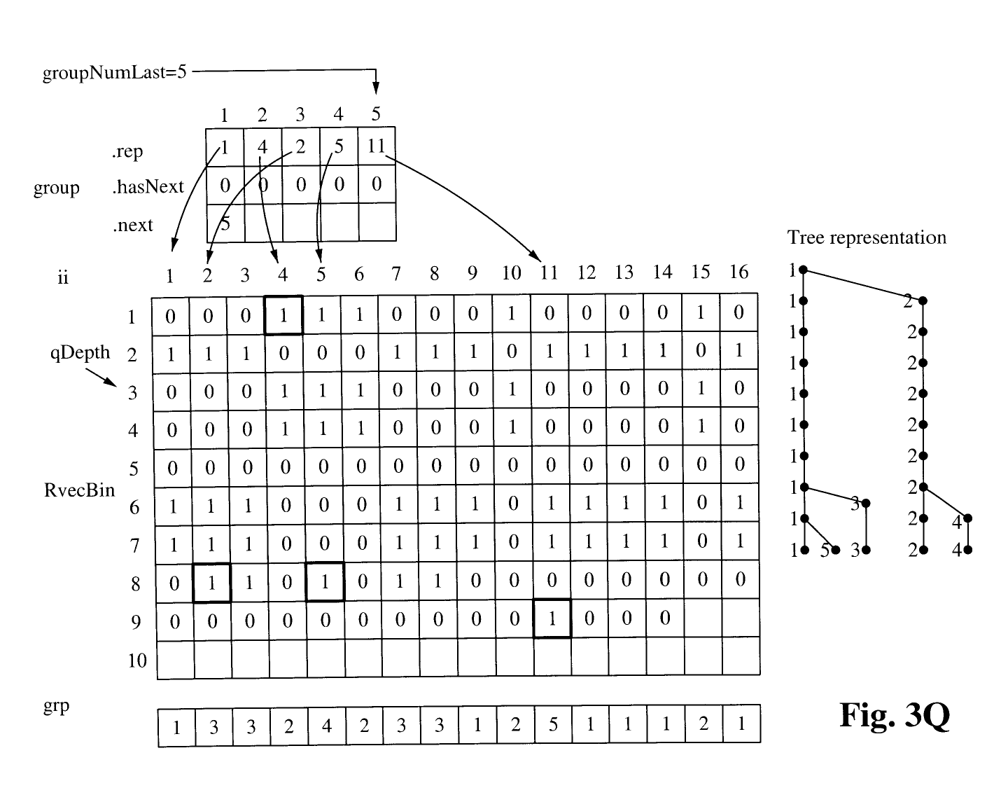

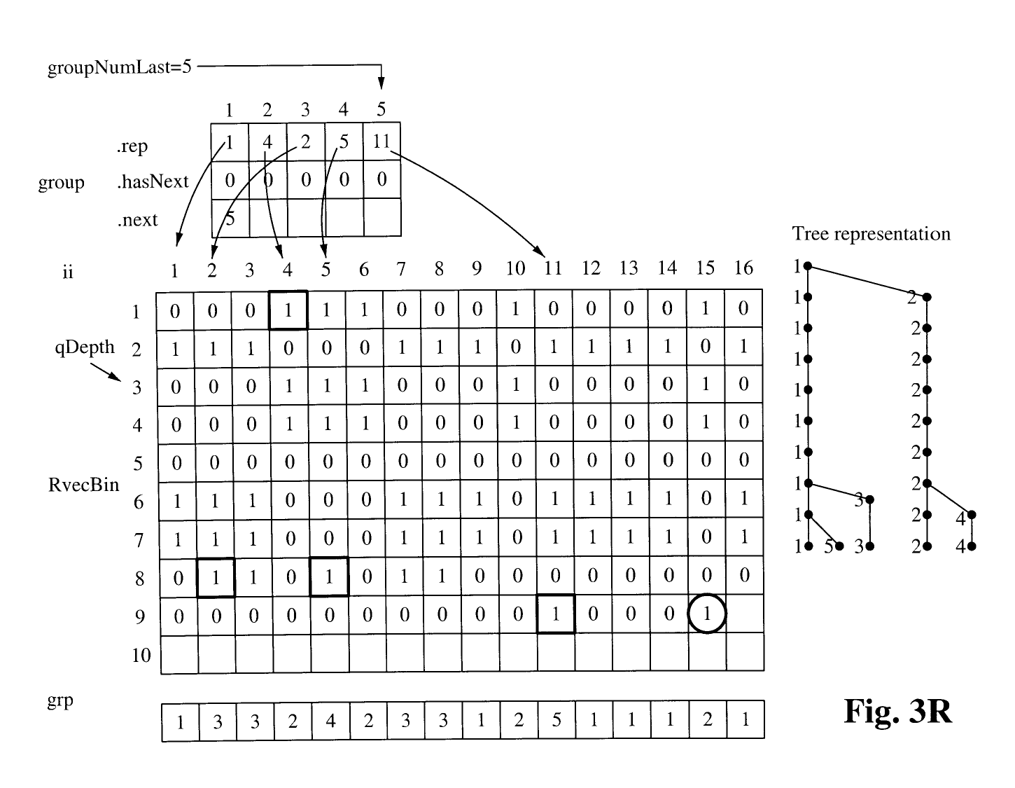

The maximum number of groups is able to be designated. For example, the maximum number of groups is 5, although any maximum number is able to be used. For each individual unique group, a separate data structure referred to as a “group” is able to be generated with fields for the pixel number (.rep in FIG. 3), whether the group has been split in the current bitplane (.hasNext in FIG. 3), and when .hasNext is 1 what is the group number for the split group in the current bitplane (.next in FIG. 3). Additional fields are able to be included as well. The process stops upon reaching the maximum number of groups allowed.

Bitstream Structure

For each block, the bitstream includes the following sequences of bits: bits indicating the selected qDepth (also referred to as qDepthBest); bits indicating the number of groups for the selected qDepth; for each group, the most significant bits are sent; for each pixel except for the first pixel, the group number of the pixel is sent; if the remaining bits from the bit budget are sufficient, then additional bits are sent for refinement; and the remaining bits up to the bit budget are sent as zeros.

For the bits indicating the selected qDepth, the value is referred to as qDepthBest, which is a fixed length coded into the bitstream. The number of bits used for coding qDepthBest depends on the number of allowed qDepthBest values.

For the bits indicating the number of groups for the selected qDepth, the value is referred to as groupNumBest, which is a fixed length coded into the bitstream. The number of bits used for coding groupNumBest depends on the number of allowed groupNumBest values.

For each pixel except for the first pixel, the group number is a fixed length coded into the bitstream, and the number of bits needed for each pixel depends on the last group number.

Decoder

The decoder receives the bits indicating the qDepthBest. The decoder also receives the bits indicating groupNumBest. For each group, the most significant qDepthBest bits of their values is received. For each pixel, the bits indicating the group number of the pixel is received, except for the first pixel in the block for which these bits are not sent since the decoder knows that the group number of the first pixel is always 1. For each pixel, the most significant qDepthBest bits of the pixel are filled with the qDepthBest bits of the group value that were received. If the remaining bits from the bit budget are sufficient, then additional bits are received as refinement and the bits fill one or more bitplanes of the pixels after the most significant qDepthBest bitplanes that are filled for each pixel. If qDepthBest plus the refLevelsNum (e.g.

the number of refinement bits for the pixel) is less than depth, the bit number qDepthBest+refLevelsNum+1 of the pixels is set to ‘1,’ and the bit number qDepthBest+refLevelsNum+2 to the LSB of the pixels is set to ‘0.’

When an image or block has more than one color component, there are several options available for coding these color components. Each color component is able to be encoded independently, all of the color components are able to be encoded jointly or some color components are encoded jointly and some are encoded independently.

Encoding Color Components Jointly For coding of two or more color components jointly, the process is similar to that described above but with the following changes: the bit budget is shared between components, the group number is not shared between the components and the value of qDepth is shared between the components. Specifically, each color component has its own groups and the groups are not shared between components. For example, the group 1 of the first color component is separate from the group 1 of the second color component. At the beginning of coding, the pixel values in each component belong to the same group in that component. For example, for the RGB case, if R, G and B are coded jointly at the beginning, the red components belong to Group 1 of red, the green components belong to Group 1 of green and the blue components belong to Group 1 of blue. When the encoder sends the qDepth, it represents the qDepth for all of the color components that are coded jointly. The selected qDepth value is shared between the color components. In the bitstream, the encoder sends a separate value of groupNumMax for each of the color components.

Additional Method for Coding Graphics Image Blocks

Additional methods are able to be used to code graphics image blocks. In the methods, the number of groups used is able to be any power of 2, for example, 2, 4 or 8. The method where there are two groups includes finding an average of all of the pixel values in the block.

Then, all of the pixels in the block with a value greater than or equal to the average value are found. The pixel members are tagged as group 1. The remaining pixels are tagged as group 2. The average value of the pixels in group 1 is computed and sent using 10 bits. The average value of the pixels in group 2 is computed and sent using 10 bits. For each pixel, 1 bit is sent to indicate its group number (e.g. 1or 2). For a block containing 16 pixels, the method yields a total of 10+10+16×1=36 bits for each block (2.25 bits per sample).

The method where four groups are used includes a recursive version of the two group method. The pixels in the block are partitioned into two groups using a method similar to that explained in the two group case. Then, for each of the groups obtained in the previous stage, the process is repeated. For a block containing 16 pixels, the method yields a total of 4×10+16×2=72 bits for each block (4.5 bits per sample).

The method where eight groups are used includes a recursive version of the two group method. The pixel is partitioned into two groups using a method similar to that explained for the two group case. For each of the groups obtained, the same process is repeated. Then, for each of the groups obtained, the same process is repeated again resulting in eight groups.

Two-Mode Codecs

In some applications, it is necessary to have a codec that works efficiently for both natural images and synthetic (graphics) images, or a mixture of natural and synthetic. In such applications, a codec that has two parts is able to be used. A first part is a sub-codec that works efficiently for natural images or natural blocks and a second part is a sub-codec that works efficiently for synthetic images or synthetic blocks. The encoder evaluates the quality of the decoded image or block and estimates which of the sub-codecs will result in a higher quality decoded image/block. Then, the encoder specifies the better sub-codec using one or more bits at the beginning of the image/block bitstream to signal to the decoder to use the corresponding decoder.

Therefore, the graphics codecs explained herein are able to be used for the graphics mode. The embedded codec described in U.S. patent application Ser. No. 12/795,210, filed Jun. 7, 2010, titled: “EMBEDDED GRAPHICS CODING FOR IMAGES WITH SPARSE HISTOGRAMS,” which is incorporated by reference herein, is another codec that is able to be used as the graphics mode for such an encoder. For the natural mode, codecs such as U.S. patent application Ser. No. 12/758,981, filed Apr. 13, 2010 and entitled, “ADAPTIVE ENTROPY CODING FOR IMAGES AND VIDEOS USING SET PARTITIONING IN GENERALIZED HIERARCHICAL TREES” and U.S. patent application Ser. No. 12/789,091, filed May 27, 2010, and entitled, “AN IMAGE COMPRESSION METHOD WITH RANDOM ACCESS CAPABILITY, which are both incorporated by reference herein, are able to be used.

FIGS. 3A-R illustrate graphs of an example of grouping according to some embodiments. Initially, there is only one group, Group 1. Then, scanning occurs in raster scan order. As is shown (FIGS. 3A-D), the first 3 bits are all part of Group 1, so nothing changes. Then, the fourth bit is read (FIG. 3E), which does not match the most recently read bit of its group representative (Group 1). Since Group 1 does not have a successor yet, Group 2 is generated as is shown in FIG. 3F. When the fifth bit is read (FIG. 3G), the bit does not match the most recently read bit of Group 1, but since Group 2 has already been generated, it is not generated again. The group number of pixel 5 is changed to Group 2. The process continues until the end of the bitplane as shown in FIG. 3H. Then, before starting with the next bitplane, the .hasNext field is cleared for the groups generated so far, as shown in FIG. 3I. FIG. 3J shows the first bit of bitplane two being read which does not cause a change Similarly, there is no change in FIGS. 3K and 3L. The process continues in FIG. 3M. In FIG. 3N, another new group is generated. Similarly, in FIG. 30, a new group is generated. Then, in FIG. 3P, the bitplane is finished. In FIG. 3Q, a fifth group is generated. Finally, in FIG. 3R, the process stops since a sixth group would be generated, but in this example, the maximum number of groups allowed is 5. FIGS. 3A-R are meant as an example and are not intended to be limiting in any way.

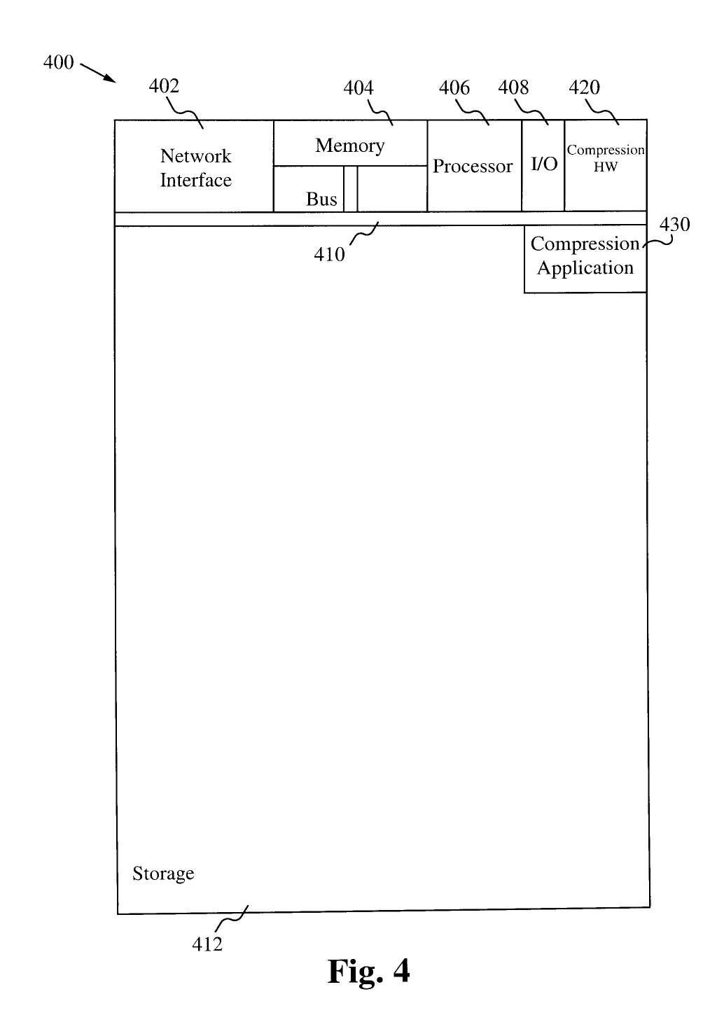

FIG. 4 illustrates a block diagram of an exemplary computing device 400 configured to implement the compression method according to some embodiments. The computing device 400 is able to be used to acquire, store, compute, communicate and/or display information such as images and videos. For example, a computing device 400 is able to acquire and store a video. The compression method is able to be used during or after acquiring the video, or when transferring the video from the device 400 to another device. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, display, printer, modem, touchscreen, button interface and other devices. Visual optimization application(s) 430 used to perform the visual optimization method are likely to be stored in the storage device 412 and memory 404 and processed as applications are typically processed. More or less components shown in FIG. 4 are able to be included in the computing device 400. In some embodiments, compression hardware 420 is included. Although the computing device 400 in FIG. 4 includes applications 430 and hardware 420 for compression, the compression method is able to be implemented on a computing device in hardware, firmware, software or any combination thereof. For example, in some embodiments, the compression applications 430 are programmed in a memory and executed using a processor. In another example, in some embodiments, the compression hardware 420 is programmed hardware logic including gates specifically designed to implement the compression method.

The computing device 400 is able to include an encoder, decoder or both. Depending on the implementation, the computing device 400 includes the components for encoding and/or decoding.

In some embodiments, the compression application(s) 430 include several applications and/or modules. As described herein, modules such as a partitioning module, a bit plane module, an encoding module and a refinement module. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a television, a home entertainment system or any other suitable computing device.

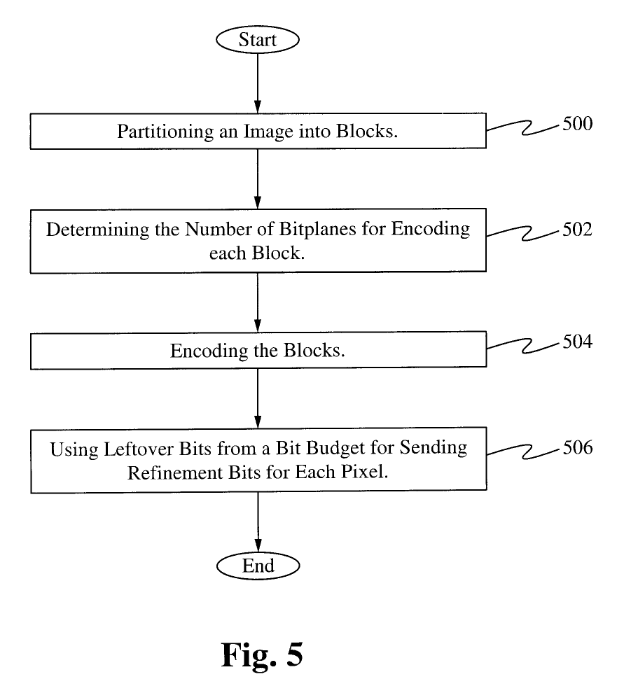

FIG. 5 illustrates a flowchart of a method of encoding a video according to some embodiments. In the step 500, an image is partitioned into blocks. In the step 502, the number of bitplanes for encoding each block is determined. In the step 504, the blocks are encoded. Encoding includes grouping pixel values so that within each group the pixel values are the same or similar, sending the number of groups and the pixel value of each group and sending a signal for each pixel to indicate the group for that pixel. In the step 506, leftover bits from a bit budget are used for sending refinement bits for each pixel. In some embodiments, fewer or additional steps are implemented.

To utilize the compression method, a user acquires a video/image such as on a digital camcorder, and while or after the video is acquired, or when sending the video to another device such as a computer, the compression method implements compression tools for each image of the video, so that the video is compressed and transferred appropriately to maintain a high quality video. The compression method occurs automatically without user involvement. Aspects of the compression method are utilized in an encoder embodiment and a decoder embodiment.

In operation, the compression method described herein provides for compression with a low hardware cost (e.g. not many logic gates are needed) in some embodiments, low complexity, low delay, very high visual quality and does not depend on other blocks for encoding. The compression method provides improved compression when transmitting encoded bits. The compression method is able to be used in any implementation including, but not limited to, wireless high definition (Wireless HD).

The compression method described herein is able to be used with videos and/or images.

High definition video is able to be in any format including but not limited to HDCAM, HDCAM-SR, DVCPRO HD, D5 HD, XDCAM HD, HDV and AVCHD.

SOME EMBODIMENTS OF COMPRESSION OF GRAPHICS IMAGES AND VIDEOS

1. A method of compression programmed in a controller in a device comprising:
a. partitioning an image into blocks;
b. determining a bit plane quantity for encoding each of the blocks; and
c. encoding each of the blocks by grouping at least similar pixel values into groups.

2. The method of clause 1 further comprising using remaining bits from a bit budget to send refinement bits for pixels.

3. The method of clause 1 wherein encoding each of the blocks includes sending a bit depth of groups, the number of groups, a pixel value of each of the groups and a signal for each pixel to indicate a group of the groups for each pixel.

4. The method of clause 1 wherein the bit depth of groups comprises a number of bit planes used for grouping (qDepthBest).

5. The method of clause 1 wherein same pixel values are grouped into the groups.

6. The method of clause 1 wherein the controller is selected from the group consisting of a programmed computer readable medium and an application-specific circuit.

7. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

8. A method of compression programmed in a controller in a device comprising:
a. partitioning an image into blocks;
b. determining an average of pixel values of each block of the blocks;
c. locating the pixel values greater than or equal to the average;
d. tagging the pixel values greater than or equal to the average as a first group; and
e. tagging remaining pixel values as a second group.

9. The method of clause 8 wherein steps a-d are repeated n times to generate 2n groups, where n is selected from 1, 2, 3, . . . a maximum.

10. A system for compression programmed in a controller in a device comprising:
a. a partitioning module for partitioning an image into blocks;
b. a determining module for determining a bit plane quantity for encoding each of the blocks; and
c. an encoding module for encoding each of the blocks by grouping at least similar pixel values into groups.

11. The system of clause 10 further comprising a refinement module for using remaining bits from a bit budget to send refinement bits for pixels.

12. The system of clause 10 wherein encoding each of the blocks includes sending a bit depth of groups, the number of groups, a pixel value of each of the groups and a signal for each pixel to indicate a group of the groups for each pixel.

13. The system of clause 10 wherein same pixel values are grouped into the groups.

14. The system of clause 10 wherein the controller is selected from the group consisting of a programmed computer readable medium and an application-specific circuit.

15. The system of clause 10 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

16. A system for compression programmed in a controller in a device comprising:
a. a natural image sub-codec for encoding natural images; and
b. a graphics image sub-codec for encoding graphics images.

17. The system of clause 16 wherein the graphics image sub-codec is implemented by:
a. partitioning an image into blocks;
b. determining a bit plane quantity for encoding each of the blocks; and
c. encoding each of the blocks by grouping at least similar pixel values into groups.

18. The system of clause 16 wherein the controller is selected from the group consisting of a programmed computer readable medium and an application-specific circuit.

19. The system of clause 16 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

20. A camcorder device comprising:
a. a video acquisition component for acquiring a video;
b. a memory for storing an application, the application for:
   i. partitioning an image of the video into blocks;
   ii. determining a bit plane quantity for encoding each of the blocks; and
   iii. encoding each of the blocks by grouping at least similar pixel values into groups; and
c. a processing component coupled to the memory, the processing component configured for processing the application.

21. The camcorder of clause 20 wherein the application is further for using remaining bits from a bit budget to send refinement bits for pixels.

22. The camcorder of clause 20 wherein encoding each of the blocks includes sending a bit depth of groups, the number of groups, a pixel value of each of the groups and a signal for each pixel to indicate a group of the groups for each pixel.

23. The camcorder of clause 20 wherein same pixel values are grouped into the groups.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of compression programmed in a controller in a device comprising:
a. partitioning an image into blocks;
b. determining a bit plane quantity for encoding each of the blocks; and
c. encoding each of the blocks by grouping at least similar pixel values into groups.

2. The method of claim 1 further comprising using remaining bits from a bit budget to send refinement bits for pixels.

3. The method of claim 1 wherein encoding each of the blocks includes sending a bit depth of groups, the number of groups, a pixel value of each of the groups and a signal for each pixel to indicate a group of the groups for each pixel.

4. The method of claim 1 wherein the bit depth of groups comprises a number of bit planes used for grouping (qDepthBest).

5. The method of claim 1 wherein same pixel values are grouped into the groups.

6. The method of claim 1 wherein the controller is selected from the group consisting of a programmed computer readable medium and an application-specific circuit.

7. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

8. A method of compression programmed in a controller in a device comprising:
a. partitioning an image into blocks;
b. determining an average of pixel values of each block of the blocks;
c. locating the pixel values greater than or equal to the average;
d. tagging the pixel values greater than or equal to the average as a first group; and
e. tagging remaining pixel values as a second group.

9. The method of claim 8 wherein steps a-d are repeated n times to generate 2ⁿ groups, where n is selected from 1, 2, 3, . . . a maximum.

10. A system for compression programmed in a controller in a device comprising:
a. a partitioning module for partitioning an image into blocks;
b. a determining module for determining a bit plane quantity for encoding each of the blocks; and
c. an encoding module for encoding each of the blocks by grouping at least similar pixel values into groups.

11. The system of claim 10 further comprising a refinement module for using remaining bits from a bit budget to send refinement bits for pixels.

12. The system of claim 10 wherein encoding each of the blocks includes sending a bit depth of groups, the number of groups, a pixel value of each of the groups and a signal for each pixel to indicate a group of the groups for each pixel.

13. The system of claim 10 wherein same pixel values are grouped into the groups.

14. The system of claim 10 wherein the controller is selected from the group consisting of a programmed computer readable medium and an application-specific circuit.

15. The system of claim 10 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

16. A system for compression programmed in a controller in a device comprising:
a. a natural image sub-codec for encoding natural images; and
b. a graphics image sub-codec for encoding graphics images.

17. The system of claim 16 wherein the graphics image sub-codec is implemented by:
a. partitioning an image into blocks;
b. determining a bit plane quantity for encoding each of the blocks; and
c. encoding each of the blocks by grouping at least similar pixel values into groups.

18. The system of claim 16 wherein the controller is selected from the group consisting of a programmed computer readable medium and an application-specific circuit.

19. The system of claim 16 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

20. A camcorder device comprising:
a. a video acquisition component for acquiring a video;
b. a memory for storing an application, the application for:
i. partitioning an image of the video into blocks;
ii. determining a bit plane quantity for encoding each of the blocks; and
iii. encoding each of the blocks by grouping at least similar pixel values into groups; and
c. a processing component coupled to the memory, the processing component configured for processing the application.

21. The camcorder of claim 20 wherein the application is further for using remaining bits from a bit budget to send refinement bits for pixels.

22. The camcorder of claim 20 wherein encoding each of the blocks includes sending a bit depth of groups, the number of groups, a pixel value of each of the groups and a signal for each pixel to indicate a group of the groups for each pixel.

23. The camcorder of claim 20 wherein same pixel values are grouped into the groups.
